(19) United States
(12) Patent Application Publication
(10) Pub. No.: US 2001/0022179 A1
(43) Pub. Date: Sep. 20, 2001

(54) Inhalation anesthesia apparatus with automatic gas flowrate control

(76) Inventor: Sebastien Kitten, Saulx Les Chartreux (FR)

Correspondence Address: YOUNG & THOMPSON, 745 SOUTH 23RD STREET 2ND FLOOR, ARLINGTON, VA, 22202

(21) Appl. No.: 09/765,303

(22) Filed: Jan. 22, 2001

(30) Foreign Application Priority Data
Jan. 21, 2000 (FR) 0000780

(51) Int. Cl. A62B 7/00

(52) U.S. Cl. 128/200.24

(57) ABSTRACT

Anesthesia apparatus comprising a gas circuit (1, 2, 3) with an inhalation branch (1) and an exhalation branch (2) forming a loop circuit (3). A manual ventilation balloon (10) forms a first gas accumulation volume, and a mechanical ventilation enclosure (13) comprises a second gas accumulation volume (14). Switching means (20) make it possible to control communication of the manual ventilation balloon (10) or of the second accumulation volume (14) with the gas circuit (1, 2, 3) in order to change over from a mechanical ventilation mode to a manual ventilation mode, or vice versa. Actuating means govern control means for fresh gas in order to permit introduction of a predefined quantity of fresh gas, into the gas circuit (1, 2, 3), in response to determination of the end of an inhalation phase and after acting on the switching means (20) to change over from a mechanical ventilation mode to a manual ventilation mode, or vice versa.

The present invention relates to the field of inhalation anesthesia and more particularly to an inhalation anesthesia apparatus comprising a main gas circuit and means for automatically controlling the flowrates of respiratory gases during the brief phases of change-over from one mode of ventilation to another mode of ventilation.

Anesthesia apparatuses conventionally include a closed system of channels or the like, also called the main circuit, intended, on the one hand, to convey to the upper airways of the patient fresh anesthetic gases issuing from a source of fresh anesthetic gas and, on the other hand, to recover the gases exhaled by the patient, permit elimination of the carbon dioxide contained in these gases exhaled by the patient, and permit recycling and mixing of these purified exhaled gases with the fresh anesthetic gases before they are returned to the upper airways of the patient.

This closed system functioning as a loop makes it possible to minimize the quantity of fresh anesthetic gas used for anesthetizing the patient.

Devices of this kind have already been described on many occasions in the prior art. For more details, reference can be made in particular to documents EP-A-643978, U.S. Pat. No. 3,687,137, EP-A-292615 or EP-A-266964.

In view of the diverse situations encountered during a surgical or medical intervention or the like involving respiratory anesthesia of the patient, carried out using a respiratory anesthesia apparatus, the person operating the apparatus, for example a doctor, nurse or the like, is obliged to modify the mode of ventilation of the patient, that is to say to change successively and alternately from a first ventilation mode to a given second ventilation mode.

Three ventilation modes are normally used during an operation requiring respiratory anesthesia of the patient, namely spontaneous ventilation mode, manual ventilation mode and mechanical ventilation mode.

In spontaneous ventilation mode, it is the patient himself who spontaneously draws in the quantity of gas he needs from a gas accumulation volume filled with an anesthetic respiratory mixture. In other words, in this mode of ventilation, it is the patient who alone and independently decides the alternation between the inhalation and exhalation phases during which the anesthetic gases are inhaled and exhaled, respectively, by the patient.

Moreover, in manual ventilation mode, the quantity of anesthetic respiratory gas necessary for the patient is insufflated by an operator, such as a doctor or the like, who manually compresses a flexible and compressible accumulation volume filled with a respiratory anesthetic mixture, for example a manual ventilation balloon.

By contrast, in mechanical ventilation mode, it is the respiratory anesthesia apparatus which automatically insufflates the quantity of anesthetic mixture necessary for the patient, said respiratory anesthetic mixture being accumulated and stored in advance in a specific accumulation volume or device.

To do this, the existing respiratory anesthesia apparatuses comprise, on the one hand, a specific accumulation volume dedicated to mechanical ventilation mode, for example a ventilation bellows, and, on the other hand, another accumulation volume dedicated, for its part, to manual ventilation mode and taking, in general, the form of a manual ventilation balloon.

During anesthesia, the practitioner is in fact made to use different ventilation modes involving the use of different members for accumulating the gases exhaled by the patient.

During these changes between modes, the circuit must continue to store a sufficient volume of gas for ventilation.

However, in the existing passive anesthesia systems, when changing from mechanical mode to assisted mode, the gases contained in the accumulation members are not transferred from one member to the other.

In a system termed “passive”, the member for accumulating the exhaled gases fills under the action of the exhalation of the patient.

In spontaneous ventilation, the manual ventilation balloon is used only to visualize the spontaneous ventilation of the patient.

By contrast, in manual ventilation, the manual ventilation balloon serves to assist the patient via a manual ventilation exerted by the practitioner.

This balloon functions in the circuit in place of the accumulation volume for gases exhaled in mechanical mode, which is generally a bellows.

If the switch-over between these two ventilation modes is effected at the end of the exhalation phase, the accumulation volume is empty whereas the accumulation volume previously present is filled with exhaled gases.

To compensate for this volume of gas not present in the circuit, the practitioner generally uses rapid oxygen which fills the new accumulation member employed.

Now, the direct consequence of this action is a modification of the concentrations established in the circuit through delivery of a quantity of pure oxygen.

The problem posed is therefore that of avoiding such a modification of the concentrations, in particular in anesthetic gas, due to delivery of pure oxygen when changing from one phase to the other.

Consequently, the present invention aims to solve the abovementioned problem by making available an anesthesia apparatus which permits automatic control of the flowrates of fresh gas during the brief phases of change-over of ventilation mode, that is to say when changing over from manual mode to mechanical mode, and vice versa.

The present invention therefore relates to a respiratory anesthesia apparatus with:

a gas circuit comprising:

(a) an inhalation branch which can convey a mixture of anesthetic gas to connection means which are intended to be connected to the upper airways of a patient; and

(b) an exhalation branch which can convey a gaseous mixture containing CO₂ exhaled by said patient, which exhalation branch includes purification means with which it is possible to eliminate at least some of the CO₂ contained in said gaseous mixture exhaled by the patient, said inhalation branch and said exhalation branch forming a loop circuit,

a manual ventilation balloon forming a first gas accumulation volume and capable of being brought into fluid communication with at least part of said gas circuit;

a mechanical ventilation enclosure comprising a second gas accumulation volume capable of being brought into fluid communication with at least part of said gas circuit;

switching means with which it is possible to control said fluid communication of the manual ventilation balloon or of the second accumulation volume of the mechanical ventilation enclosure with said gas circuit, to permit change-over from a mechanical ventilation mode to a manual ventilation mode, or vice versa,

means for determining the respiratory phase, making it possible to determine the start and/or the end of an inhalation or exhalation phase of the patient,

means for controlling the supply of fresh gas, and

actuating means controlling said control means for fresh gas in order to permit introduction of a pre-defined quantity of fresh gas, into the gas circuit, in response to determination of the end of at least one inhalation phase of the patient by said determination means and after acting on said switching means to change over from a mechanical ventilation mode to a manual ventilation mode, or vice versa.

Depending on circumstances, the apparatus can comprise one or more of the following characteristics:

the mechanical ventilation enclosure includes a ventilation bellows;

the switching means are electropneumatic valves controlled by said actuating means;

the means for controlling the supply of fresh gas include at least one solenoid valve controlled by said actuating means;

the means for determination of respiratory phase are a device including at least one pressure sensor and/or flowrate sensor connected electrically to said actuating means, or an electronic automatic member with which it is possible to supply at least one mechanical ventilation phase duration to said actuating means.

In addition, the invention also relates to a method for controlling an apparatus according to the invention in order to permit change-over from a manual ventilation mode to a mechanical ventilation mode, which method comprises the following steps:

(a) switching the apparatus in machine mode by acting on the switching means in order to bring the gas accumulation member of the mechanical ventilation enclosure into fluid communication with the gas circuit;

(b) acting on the control means for supply of fresh gas in order to permit introduction of a quantity of fresh gas into the respiratory gas circuit and/or into the gas accumulation member of the mechanical ventilation enclosure until the gas accumulation member is at least partially filled with said fresh gas.

Moreover, the invention also relates to a method for controlling an apparatus according to the invention in order to permit change-over from a mechanical ventilation mode to a manual ventilation mode, which method comprises the following steps:

(a) switching the apparatus in manual mode by acting on the switching means in order to bring the manual ventilation reservoir into fluid communication with the gas circuit;

(b) detecting at least one inhalation phase and/or at least one exhalation phase of the patient; and

(c) acting on the control means for supply of fresh gas in order to permit introduction of a quantity of fresh gas into the respiratory gas circuit and/or into the manual ventilation reservoir until the manual ventilation member is at least partially filled with said fresh gas.

Depending on circumstances, the control methods according to the invention can comprise one or more of the following characteristics:

complete filling of the ventilation member is carried out;

at least the end of an inhalation phase of the patient is detected by way of the respiratory phase detection means;

the fresh gas is a mixture containing nitrogen and oxygen, and optionally one or more anesthetic compounds.

The invention will now be described in greater detail with reference to the attached figures which show an embodiment of an apparatus according to the invention, given by way of nonlimiting illustration.

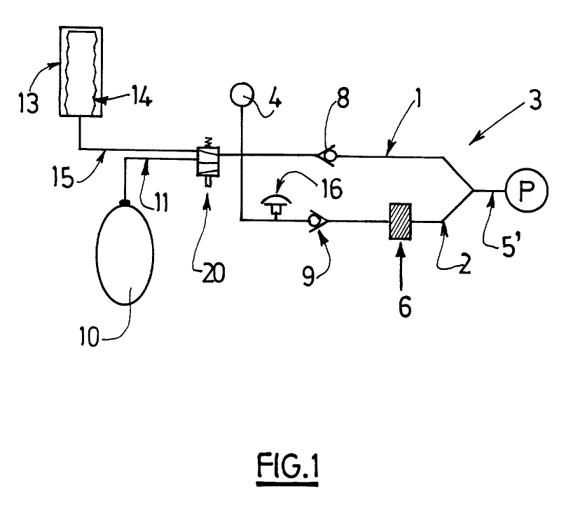

FIG. 1 shows a diagram of a respiratory anesthesia apparatus according to the invention, which apparatus includes a looped gas circuit 3 formed by an inhalation branch 1 and an exhalation branch 2.

The inhalation branch 1 conveys an anesthetic respiratory gas from a source 4 of anesthetic respiratory gas to connection means 5 which are connected to the upper airways of a patient P, and said connection means 5 can be a respiratory mask, an intubation probe or any similar means.

Conversely, with the exhalation branch 2 it is possible to collect the gases exhaled by the patient P during the exhalation phases, said exhaled gases being rich in carbon dioxide (CO₂) and containing anesthetic products which it is desirable to be able to recover and recycle with a view to subsequently returning them to the patient P.

Said inhalation 1 and exhalation 2 branches form a looped circuit 3, also called a closed circuit.

The inhalation branch 1 or the exhalation branch 2 is equipped with a valve 16 for release to the atmosphere with which it is possible to eliminate any overpressure within said inhalation branch, which overpressure could be harmful to the patient P.

Moreover, the exhalation branch 2 includes purification means 6, such as a purification device containing an adsorbent, for example lime or the like, intended to eliminate most of the CO₂ contained in the gases exhaled by the patient.

In addition, the inhalation branch 1 and the exhalation branch 2 are equipped with nonreturn flaps or valves 8 and 9, respectively.

The anesthesia apparatus in FIG. 1 also comprises a manual ventilation balloon 10 forming a gas accumulation volume, which is connected via a line 11 to the looped gas circuit 3, downstream of the purification device 6 intended to eliminate the CO₂ in the gases exhaled by the patient P.

In addition, the respiratory anesthesia apparatus includes a mechanical ventilation enclosure 13, inside of which is inserted a mechanical ventilation bellows 14 which is connected to the gas circuit 3 via a line 15.

Switching means 20 are arranged between the gas circuit 3 and said lines 11 and 15 in such a way as to control the circulations of gas between, on the one hand, the manual ventilation balloon 10 and bellows 14, and, on the other hand, said gas circuit 3, and vice versa.

According to the present invention, when changing from manual mode to mechanical mode, the flowrate of fresh gas is increased and a defined volume of gas, i.e. the volume of the mechanical accumulator, is introduced into the circuit 3 in order to fill the new accumulator employed, that is to say the bellows 14.

Conversely, in the case of changing from mechanical mode to manual mode, the ventilator waits until the end of insufflation in automatic mode in order to change over to manual mode, so as to empty and replace the bellows 14 by the manual accumulator 10 and fill the latter on the one hand with the gases exhaled by the patient and on the other hand with fresh gases introduced into the circuit 3 or residual gases contained in the bellows 14. In other words, the two accumulators 10 and 14 are brought into communication in order to transfer the gas remaining in the bellows 14, after insufflation, to the manual accumulator 10.

All these switching operations from one ventilation mode to another ventilation mode are governed electronically by means of valves actuated by a microprocessor unit upon each detection of an instruction to change ventilation mode.

1. A respiratory anesthesia apparatus with:
a gas circuit (1, 2, 3) comprising:
(a) an inhalation branch (1) which can convey a mixture of anesthetic gas to connection means (5) which are intended to be connected to the upper airways of a patient; and
(b) an exhalation branch (2) which can convey a gaseous mixture containing CO₂ exhaled by said patient, which exhalation branch (2) includes purification means (6) with which it is possible to eliminate at least some of the CO₂ contained in said gaseous mixture exhaled by the patient, said inhalation branch (1) and said exhalation branch (2) forming a loop circuit (3),
a manual ventilation balloon (10) forming a first gas accumulation volume and capable of being brought into fluid communication with at least part of said gas circuit (1, 2, 3);
a mechanical ventilation enclosure (13) comprising a second gas accumulation volume (14) capable of being brought into fluid communication with at least part of said gas circuit (1, 2, 3);
switching means (20) with which it is possible to control said fluid communication of the manual ventilation balloon (10) or of the second accumulation volume (14) of the mechanical ventilation enclosure (13) with said gas circuit (1, 2, 3), to permit change-over from a mechanical ventilation mode to a manual ventilation mode, or vice versa,
means for determining the respiratory phase, making it possible to determine the start and/or the end of an inhalation or exhalation phase of the patient,
means for controlling the supply of fresh gas, and
actuating means controlling said control means for fresh gas in order to permit introduction of a pre-defined quantity of fresh gas, into the gas circuit (1, 2, 3), in response to determination of the end of at least one inhalation phase of the patient by said determination means and after acting on said switching means (20) to change over from a mechanical ventilation mode to a manual ventilation mode, or vice versa.

2. The apparatus as claimed in claim 1, characterized in that the mechanical ventilation enclosure (13) includes a ventilation bellows (14).

3. The apparatus as claimed in either of claims 1 and 2, characterized in that the switching means (20) are electropneumatic valves controlled by said actuating means.

4. The apparatus as claimed in either of claims 1 and 2, characterized in that the means for controlling the supply of fresh gas include at least one solenoid valve controlled by said actuating means.

5. The apparatus as claimed in either of claims 1 and 2, characterized in that the means for determination of respiratory phase are a device including at least one pressure sensor and/or flowrate sensor connected electrically to said actuating means, or an electronic automatic member with which it is possible to supply at least one mechanical ventilation phase duration to said actuating means.

6. A method for controlling an apparatus as claimed in one of claims 1 through 5, in order to permit change-over from a manual ventilation mode to a mechanical ventilation mode, which method comprises the following steps:
(a) switching the apparatus in machine mode by acting on the switching means in order to bring the gas accumulation member of the mechanical ventilation enclosure into fluid communication with the gas circuit;
(b) acting on the control means for supply of fresh gas in order to permit introduction of a quantity of fresh gas into the respiratory gas circuit and/or into the gas accumulation member of the mechanical ventilation enclosure until the gas accumulation member is at least partially filled with said fresh gas.

7. A method for controlling an apparatus as claimed in one of claims 1 through 5, in order to permit change-over from a mechanical ventilation mode to a manual ventilation mode, which method comprises the following steps:
(a) switching the apparatus in manual mode by acting on the switching means in order to bring the manual ventilation reservoir into fluid communication with the gas circuit;
(b) detecting at least one inhalation phase and/or at least one exhalation phase of the patient; and
(c) acting on the control means for supply of fresh gas in order to permit introduction of a quantity of fresh gas into the respiratory gas circuit and/or into the manual ventilation reservoir until the manual ventilation member is at least partially filled with said fresh gas.

8. The method for controlling an apparatus as claimed in claim 6 or 7, characterized in that complete filling of the ventilation member is carried out.

9. The method for controlling an apparatus as claimed in claim 6 or 7, characterized in that at least the end of an inhalation phase of the patient is detected by way of the respiratory phase detection means.

10. The method for controlling an apparatus as claimed in claims 6 through 9, characterized in that the fresh gas is a mixture containing nitrogen and oxygen, and optionally one or more anesthetic compounds.
